(19) United States
(12) Patent Application Publication
(10) Pub. No.: US 2013/0284162 A1
(43) Pub. Date: Oct. 31, 2013

(54) HELIOSTAT CALIBRATION AND CONTROL

(71) Applicant: Alexander Ian Burton, New South Wales (AU)

(72) Inventor: Alexander Ian Burton, New South Wales (AU)

(73) Assignee: Limestone Avenue Campbell, Australian Capital Territory (AU)

(21) Appl. No.: 13/997,342

(22) PCT Filed: Dec. 22, 2011
(86) PCT No.: PCT/AU2011/001687

§ 371 Date: Jun. 24, 2013

(30) Foreign Application Priority Data
Dec. 22, 2010 (AU) 2010905600
Dec. 22, 2010 (AU) 2010905601

(51) Int. Cl. F24J 2/38; G01S 3/786

(52) U.S. Cl. CPC F24J 2/38; G01S 3/7861
USPC 126/601; 126/714

(57) ABSTRACT

A solar energy collector including a solar energy receiver defining a primary target; and a field of heliostats mounted for angular adjustment to receive and direct sunlight to the primary target and an actuator to effect the angular adjustment of each heliostat. A secondary target at or spaced from the primary target. A controller coupled to the actuator configured to sequentially cause, a temporary angular adjustment of the respective the heliostats so as to divert the beam of sunlight received at each heliostat to the secondary target for a predetermined period of time. A recorder to record a representation of each diverted beam at the secondary target. The controller is coupled to the recorder and further configured to respond to the representation of the diverted beam for the respective heliostats when a parameter deviates from norm, by activating the actuator to angularly adjust the corresponding heliostat.

### FIELD OF THE INVENTION

This invention relates generally to solar energy collection apparatus of the kind having a central solar energy receiver, typically on a tower, and an array of heliostats, commonly known as a solar field, mounted for angular adjustment to optimally receive a beam of sunlight and direct it to the central receiver. There may be more than one central receiver. More particularly, the invention is concerned with the calibration and control of the heliostats, both individually and collectively. Solar energy collection apparatus of the aforementioned kind is referred to herein as a central receiver solar energy collection system.

### BACKGROUND OF THE INVENTION

A challenge with central receiver solar energy collection systems is the trade off, in relation to the heliostats, between manufacturing cost and manufactured accuracy. A large solar field may have many hundreds, even thousands, of heliostats and so the overall economic performance of the system may be dependent upon achieving a low unit cost in the manufacture of each heliostat, including the actuator configuration for angularly adjusting the heliostat. On the other hand, inexpensive manufacture will generally come with high tolerances that will give rise to substantial variations in the optical characteristics across the heliostats of a large field. One way to address this issue is to obtain a geometrical calibration or characterisation of each heliostat mirror.

For example, in Australian patent AU2002244529, it is proposed to geometrically characterise a heliostat mirror by reflecting multiple laser beams from the mirror onto a detection screen or detection array. The array of laser beams may be moved relative to the mirror and a snapshot taken of the array of detection spots at regular intervals, for example with a suitable camera or similar device. The proposal is to characterise the mirror surface and then compensate for its imperfections without, as previously, mechanically working or improving the mirror surface (i.e., increasing the manufacturing cost). There is also disclosure about employing the characterisation of multiple mirror surfaces to determine a simulation of a response to sunlight, which can be employed in turn to derive an optimum mirror array to optimise the solar energy collection at a receiver.

Australian patent application AU2008201847 discloses determining a preferred pattern of light reflection for each of multiple mirrors of a heliostat array, observing reflected light from the respective mirror, comparing this reflected light pattern with the preferred light pattern and then adjusting the mirror to obtain the preferred light pattern.

International patent publication WO 97/01030 discloses obtaining an image of an entire heliostat array or array of facets. In one embodiment, the image plane is beyond the focal point within the receiver, while in another there is a reflector beyond the focal point that directs the image onto an image plane, e.g. substantially coincident with the main target plane. By employing a multi-component detection plane or image plane, the response and image of each heliostat or each heliostat facet can be recorded, and this information may be used to adjust the heliostat or facet.

International patent publication WO 2009/103077 is concerned with categorising heliostats of a field according to individual calibration profiles, and then assigning to each heliostat a program of aiming points at the receiver, based on the categorisation and the profiles.

U.S. Pat. No. 4,564,275 provides a calibration technique which eliminates resurveying and field work and provides a method of aligning a single heliostat or a number of heliostats at the same time. The technique relies on changing the aimpoint from the receiver to a reference position on a target, with a radiometer used to determine the beam centroid error which is then used to re-align the heliostat. A problem with this technique is that it does not address the calibration of inexpensive and inaccurate heliostats.

United States Patent application publication US2010/0252024 provides a calibration technique in which a misaligned heliostat is detected in an off-focal area location that surrounds the receiver aperture, thereby establishing a communication link between the heliostat and the off-focal area. A processor is then used to re-align the heliostat. A problem with this technique is that the magnitude of the misalignment is relatively large before corrective action is required. As a result the heliostat field would be susceptible to operate for extended periods at suboptimal heliostat alignment and hence sub optimal heliostat field performance.

It is an object of the present invention to provide improved calibration and control arrangements for a central receiver solar energy collection system that facilitate the use of inexpensive and therefore less accurately manufactured heliostats.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

In a first aspect, the invention provides solar energy collection apparatus comprising:
a solar energy receiver defining a primary target to receive directed sunlight;
a field of heliostats mounted for angular adjustment to optimally receive a beam of sunlight and direct it to the primary target of the solar energy receiver;
actuator means to effect said angular adjustment of each heliostat of the field;
a secondary target at or spaced from said primary target disposed so as not to be intercepted by said optimally received and directed beams of sunlight;
a controller operably coupled to said actuator means and configured to sequentially cause, during operation of the solar energy collection apparatus, a temporary angular adjustment of the respective said heliostats so as to divert the beam of sunlight received at each heliostat to said secondary target for a predetermined period of time; and
recordal means to record a representation of each diverted beam at the secondary target;
wherein the controller is also coupled to the recordal means and is further configured to respond to the representation of the diverted beam for the respective heliostats when a parameter or element thereof deviates from a reference norm, by activating the actuator means to angularly adjust the corresponding heliostat to improve the accuracy of its receipt of said beam of sunlight and direction of the beam to the primary target, thereby compensating by closed loop control of the field of heliostats during operation of the apparatus for tolerances in heliostat and actuator geometries.

At least in preferred embodiments, the present invention represents a paradigm shift in heliostat field design and operation, wherein high precision inclinometers and encoders conventionally used to ensure a high degree of accuracy is maintained by each heliostat are substituted by low precision (e.g. 8 bit) encoders and a continuous closed loop control system which ensures the heliostats are continuously and systematically re-aligned for optimal performance.

The closed loop calibration system is preferably based on inexpensive 8 bit encoders (preferably hall effect encoders) rather than optical encoders/inclinometers (˜12-16bit) yet provides high precision angular positioning of a heliostat without high instrumentation costs or precision. The price differential between the 8 bit encoders and the 12-16 bit optical encoders/inclinometers is in the order or 100 fold or more.

By “low precision” herein in relation to sensors or encoders for determining the angular position of a heliostat mirror is meant precision of a similar order to that obtained by an 8 bit hall effect encoder.

The continuous closed loop control system of the present invention also provides for further capital expenditure savings through enabling low precision manufacturing and installation techniques to be employed without detrimentally affecting heliostat field performance, e.g. footings can be aligned using a string line without too much concern over high precision placement.

The control system will compensate for these errors by algorithmic and mathematical methods to correctly target a heliostat by compensating for installation, mechanical, positional and measurement errors.

The invention further provides, in its first aspect, a method of calibrating multiple heliostats of a solar energy collection apparatus that includes a solar energy receiver defining a primary target to receive directed sunlight, and a field of heliostats mounted for angular adjustment to optimally receive a beam of sunlight and direct it to the primary target of the solar energy receiver, the method comprising:
during operation of the solar energy apparatus, sequentially causing a temporary angular adjustment of the respective said heliostats so as to divert the beam of sunlight received at each heliostat to a secondary target for a predetermined period of time, which secondary target is at or spaced from the primary target and disposed so as not to be intercepted by said optimally received and directed beams of sunlight,
thereafter returning the heliostat to a position in which the received beam of sunlight is directed to the primary target,
recording a representation of each directed beam at the secondary target; and
responding to the representation of the diverted beam for the respective heliostats when a parameter or element thereof deviates from a reference norm, by angularly adjusting the corresponding heliostat to improve the accuracy of its receipt of said beam of sunlight and direction of the beam to the primary target, thereby compensate by closed loop control of the field of heliostats during operation of the apparatus for tolerances in heliostat and actuator geometries.

Preferably, the controller is further configured so that on a continuous basis during operation of the solar energy collection apparatus, at least one heliostat is in a state of said temporary angular adjustment, whereby said closed loop control is a continuous closed loop control.

The solar energy receiver may typically be on a tower adjacent the field of heliostats. The secondary target is them preferably also on the tower.

The primary target may comprise an aperture to receive the directed beams of sunlight.

In an advantageous application, the actuator means includes a pair of linear actuators for respectively controlling the inclination and declination of a reflecting surface of the heliostat. The heliostats may include a mirror, a support frame for the mirror, and an intermediate mount for the frame. The pair of linear actuators are preferably arranged for respectively rotationally adjusting the intermediate mount about a first axis and rotationally adjusting the frame relative to the intermediate mount about a second axis. The axes may comprise a horizontal inclination axis and an upright axis generally orthogonal to the inclination axis.

In an embodiment each heliostat comprises a mirror secured by adhesive to a backing frame comprising multiple ribs arranged to that the mirror exhibits a shallow concave paraboloid profile. The ribs may be shaped from sheet metal.

The secondary target preferably comprises a highly reflective surface, in which case the aforesaid representation may be a two dimensional flux image representative of a cross section of any sunlight beam that impinges on the secondary target.

The recordal means is advantageously a camera at or near a ground surface on which the field of heliostats is mounted. The controller is typically further coupled to the recordal means.

In preferred embodiments the temporary angular adjustment is in the range 1 to 10°, more preferably 1 to 6°, most preferably 2 to 5°. The predetermined period of time is preferably in the range 1 second to 1 minute, more preferably 1 to 30 seconds, still more preferably 1 to 20 seconds, most preferably 1 to 10 seconds.

The controller may be further configured to cause a said representation to be acquired for each of multiple heliostats at different times over a day and over an extended period of multiple days and for corresponding angular positions of the heliostat, whereby to obtain a calibration model for the heliostats with respect to multiple time points as well as the geometry of the heliostats, and whereby to achieve a combination of open loop and closed loop control of the positions of the heliostats.

The combination of open loop (from calibrations) and closed loop (from offsets) positioning results in highly accurate tracking, allowing compensation for the employment of inexpensive heliostat actuation fabrication methods, and for the consequent substantial tolerances in heliostat and actuator geometries.

In an embodiment of the invention, the controller may be further configured to manage or control flux end thermal performance of the primary target and/or receiver by diverting one or more heliostat beams to the secondary target, which thereby serves as a stand-by receiver.

In a second aspect, the invention provides solar energy collection apparatus comprising:
a solar energy receiver defining a primary target to receive directed sunlight;
a field of heliostats mounted for angular adjustment to optimally receive a beam of sunlight and direct it to the primary target of the solar energy receiver;
actuator means to effect said angular adjustment of each heliostat of the field;
a secondary target;
means to record a representation of each directed beam at the secondary target, which representation is a characterisation of the corresponding heliostat at that time; and
a controller operably coupled to the representation recording means and configured to cause a said representation to be acquired for each of multiple heliostats at different times over a day and over an extended period of multiple days and for corresponding angular positions of the heliostat, whereby to obtain a calibration model for the heliostats with respect to multiple time points as well as the geometry of the heliostats.

In its second aspect the invention also provides a method of calibrating solar energy collection apparatus that includes a solar energy receiver defining a primary target zone to receive directed sunlight and a field of heliostats mounted for angular adjustment to optimally receive a beam of sunlight and direct it to the primary target of the solar energy receiver, the method comprising the steps of:
recording a representation of each directed beam at a secondary target, which representation is a characterisation of the corresponding heliostat at that time; and
acquiring such a representation for each of multiple heliostats at different times over a day and over an extended period of multiple days and for corresponding angular positions of the heliostat, whereby to obtain a calibration model for the heliostats with respect to multiple time points as well as the geometry of the heliostats.

Where applicable the preferred, optional and advantageous features set out above in relation to the first aspect of the invention may also apply to the second aspect.

The invention is also directed to the first and second aspects of the invention in combination.

As used herein, except where the context requires otherwise, the term “comprise” and variations of the term, such as “comprising”, “comprises” and “comprised”, are not intended to exclude further additives, components, integers or steps.

Reference herein to a “continuous basis during operation” or to a “continuous” action (e.g. closed loop control) means that the action referred to is being effected for at least 80%, preferably at least 90% and more preferably 100% of the time the heliostat field is in operation. According to context, for example, the action may comprise at least one heliostat being angularly adjusted so as to divert the beam of sunlight received at the heliostat to a secondary target, or a representation of a beam directed to the secondary target being recorded.

### BRIEF DESCRIPTION OF THE FIGURES

The invention will now be further described, by way of example only, with reference to the accompanying figures in which:

FIG. 1 is a view of a small central receiver solar energy collection system according to an embodiment of the invention;

FIG. 2 is a plan diagram of a suitable field of heliostats for the system depicted in FIG. 1;

FIG. 3 is a perspective view from below of the tower-mounted central receiver and the secondary target;

FIG. 4 is a functional block diagram of the main components of the solar energy collection system, including the controller;

FIG. 5 is a rear perspective view of a typical heliostat;

FIG. 6 is a plan view of the heliostat depicted in FIG. 5 viewed parallel to the plane of the frame;

FIG. 7 is a rear elevation of the heliostat depicted in FIG. 5;

FIG. 8 is a side elevation of the heliostat depicted in FIG. 5 viewed parallel to the plane of the frame;

FIG. 9 is a front view of the heliostat depicted in FIG. 5;

FIG. 10 is a fragmentary perspective side view of the central hub of the heliostat frame;

FIG. 11 is a plan view of an arm of the heliostat frame;

FIGS. 12 and 13 are side and front views respectively of the frame support of the heliostat of FIG. 5;

FIGS. 14 to 16 are top, front and side views of the heliostat post including the mount for the frame support bracket;

FIG. 17 is a diagram of the secondary target with a representative flux image of a heliostat-reflected beam; and

FIG. 18 is a diagrammatic representation of the closed loop control system.

### DESCRIPTION OF EMBODIMENTS OF THE INVENTION

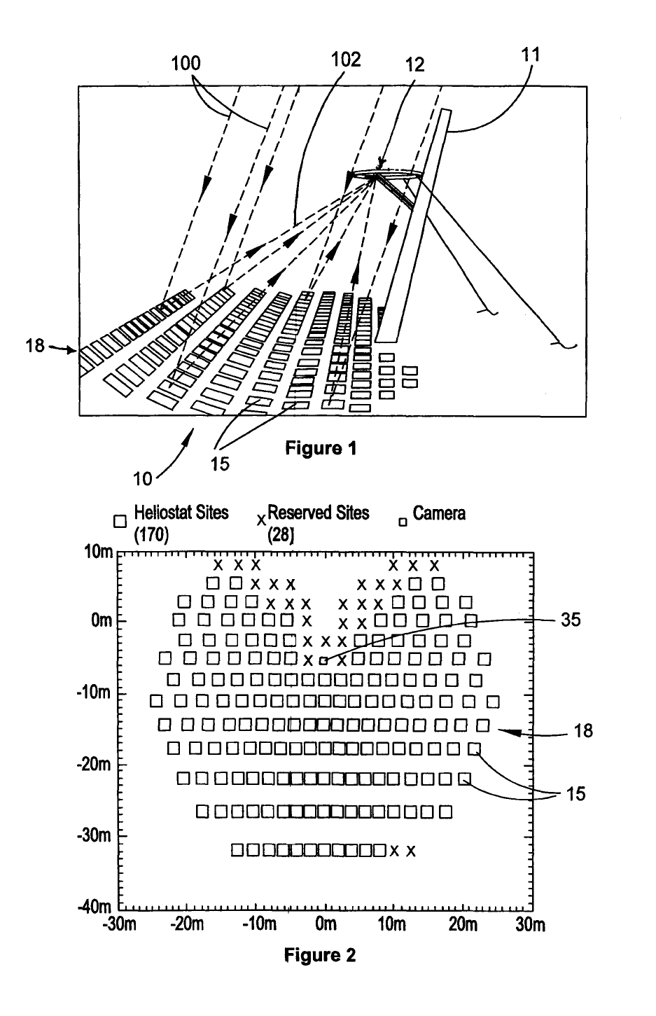

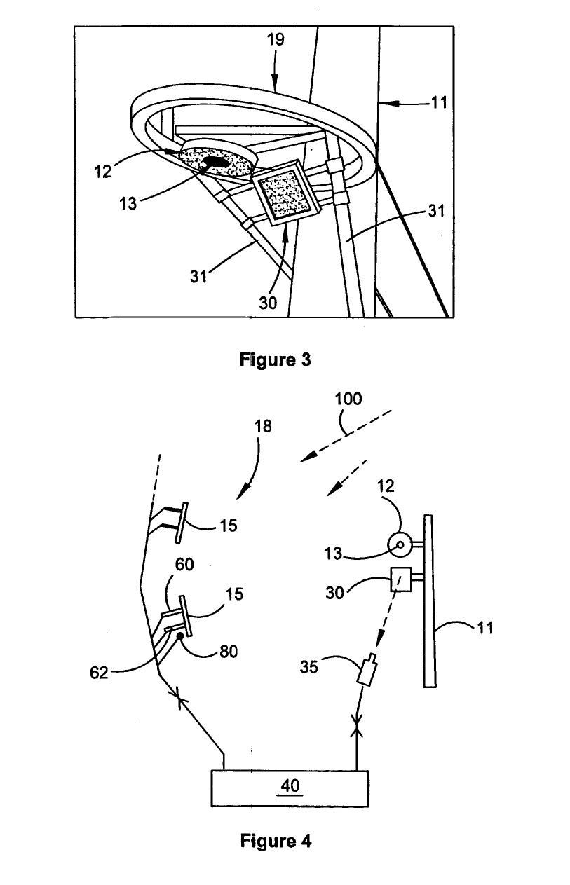

The present invention has particular utility in the operation of a central receiver solar energy collection system utilising inexpensively manufactured heliostats. Such a system 10 is depicted in FIGS. 1 and 2. The system comprises a central solar energy receiver 12 mounted in cantilevered fashion from a tower 11 above and in front of a large array or field 18 of heliostats 15. Heliostats 15 are mounted for angular adjustment to optimally receive a respective beam of sunlight 100 and to direct the beam, as a directed beam 102, to the solar receiver 12. Receiver 12 has an aperture 13 (FIG. 3) that defines a primary target to receive the directed beams of sunlight from the heliostats.

An optimally receiving position in this context is the angular position of the heliostat determined by a central controller, discussed further below, to be the appropriate position at the particular time on the particular date at which the respective heliostat makes a desired contribution to the energy flux incident on the receiver target 13. In general, the objective is to best approximate the desired flux levels and flux distribution at the receiver.

Receiver 12 hangs downwardly from a supporting cantilever framework 19 fixed to tower 11. Also fitted to framework 19, by being suspended between a pair of inclined struts 31, is a secondary or auxiliary target 30 (FIG. 3). The secondary target is, in this case, spaced from the primary target and disposed so as not to be intercepted by the optimally received and directed beams of light from the heliostats. In this embodiment, the secondary target is a highly reflective rectangular surface on which is trained a camera 35. Camera 35 is mounted on the ground below the receiver at the position indicated in FIG. 2, and is designed to record a two-dimensional flux image representative of a cross-section of any sunlight beam that impinges on the secondary target.

Each heliostat 15, has an individual actuator system 21 typically comprising a pair of linear actuators 60, 62 (FIG. 4) for respectively controlling the inclination and declination of the heliostat's reflecting surface. The angular position of each heliostat, both inclination and declination, is determined by a central controller 40 (FIG. 4) which may comprise a suitable computer system. This controller is operably coupled to the actuators 60, 62 of all of the heliostats, to magnetic sensors 80 by which the controller is kept informed of actual angular position co-ordinates of each heliostat, and to camera 35. As well as activating and deactivating the system 10 into and out of operation, controller 40 is programmed to carry out a number of calibration and control tasks in order to optimise the convertible energy received at primary target aperture 13.

An example of a functional small field central receiver solar energy collection system of the type depicted in FIGS. 1 to 4 is a close packed field of 170 heliostats of rectangular shape measuring about 2.4 metres by 1.84 metres and having a shallow concave reflecting surface with focal lengths between 15 and 38 metres, according to their position in the field. The field is designed for maximum annual energy collection by a receiver aperture 13 of diameter 0.8 m at an elevation of 17 metres at an angle of 17° to the horizontal. In an alternative arrangement there may be two receivers with associated apertures to which respective halves of the field 18 are focused during operation.

In this context “maximum energy collection” refers to maximising the energy during early morning and late afternoon times when one is typically using nearly 100% of the field (which is on-line) to achieve the desired power level. The term also refers to how much light gets through the aperture 13, which is the total light reflected by the mirror minus the light hitting the shield around the aperture: the better the mirror of the heliostat is aimed, the less light is lost on the heat shield and more light gets through the aperture.

The system may be used to produce SolarGas™, which is formed in a natural gas reforming process that stores solar energy in the chemical bonds of the gas. It is also highly suitable for other applications such as high temperature steam production, hydrogen production, spectral beam splitting and materials testing. The SolarGas™ can then be processed into solar hydrogen. This enables solar energy to be stored and transported; this technology serves as a transitional route toward higher levels of solar penetration in the energy mix.

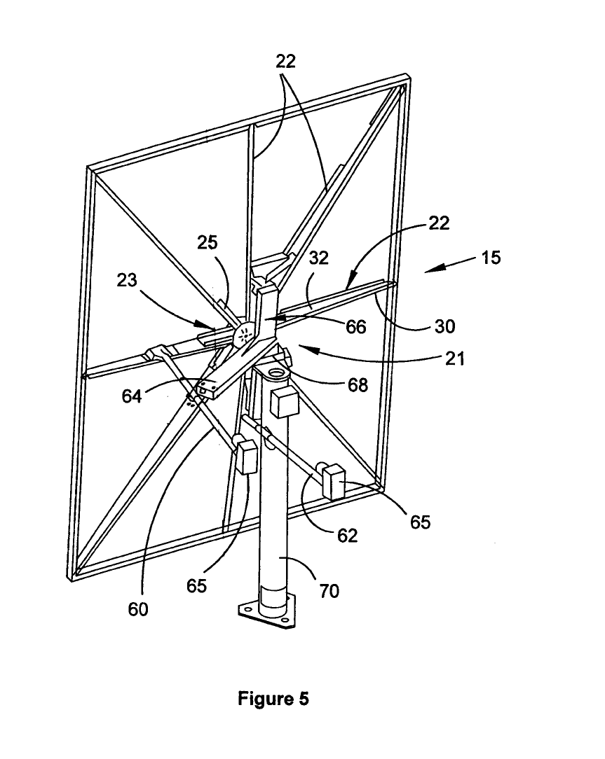

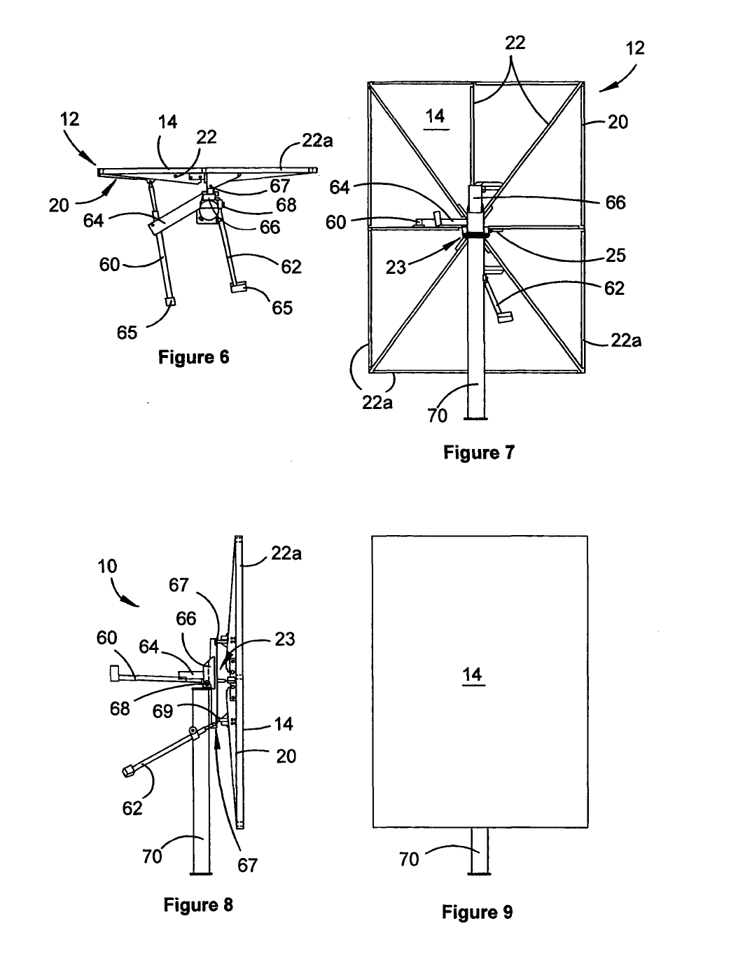

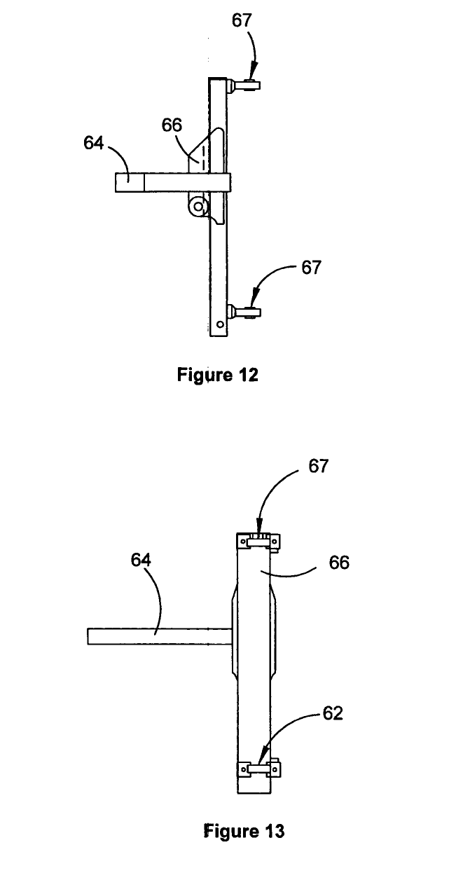

A suitable heliostat 15 with respective actuators 60, 62 is illustrated in FIGS. 5 to 9, and certain individual components are further detailed in FIGS. 10 to 16.

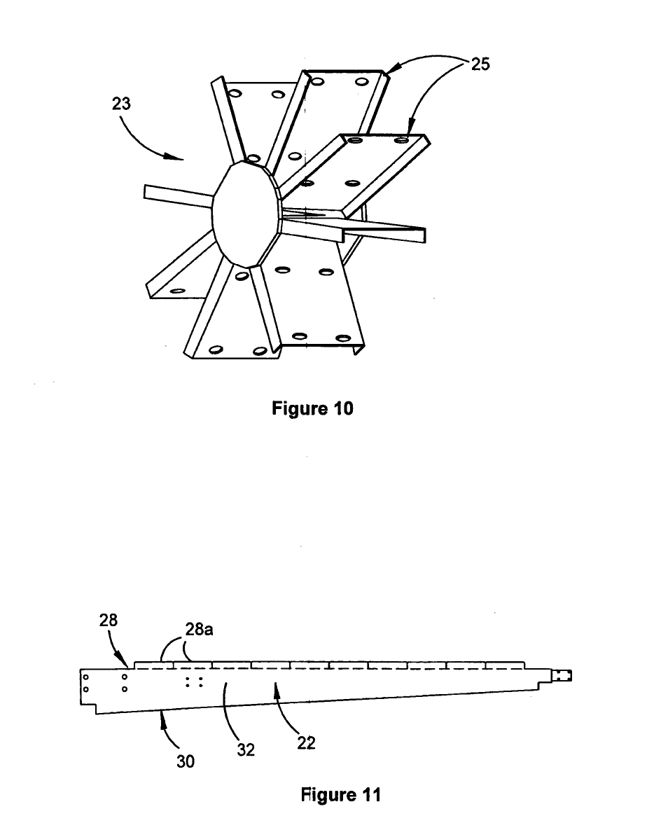

Heliostat 15 includes a large concave mirror 14 fixed by adhesive to a backing frame 20 of rectangular profile. Frame 20 is mounted atop a stand or post 70, by means to be described, and comprises a central hub 23 and ribs 22 that extend radially from central hub 23 to peripheral edge beams 22a. The ribs 22 are pre-manufactured to have a desired shape that provides the frame with particular paraboloid curvature when the frame 20 is assembled. The ribs 22 are fastened to corresponding flat radial arms 25 of hub 23 (see FIG. 9). The mirror 14 lies on the concave side. The dimensions of the components are determined by a frame pattern which is generated by software. Fasteners such as thread forming screws, rivets, spot welding or bolted joints are used throughout the frame 20.

The ribs of the frame are manufactured from sheet metal, e.g. galvanised sheet steel, laser cut (or die cut) and folded. The ribs 22 optionally have slots and tabs cut on a front curved face that may be bent by hand. The ribs 22 are shaped into a broad C or channel cross-section that defines a flat web 32 and edge flanges 28, 30: one of these abuts and is adhered to mirror 14. Web 32 tapers outwardly from a wider inner end fastened to a corresponding hub arm 25. The mirror 14 is glued directly to the frame 20 using a polyurethane based adhesive applied to folded tabs 28a on the inner edge flanges 28 of all the ribs 22, which as already noted collectively define a shallow concave paraboloid shape. The mirror is typically made of 3 mm thick glass having a high reflectivity surface, such as a plastic composite, and a low iron content to reduce energy absorption. Suitable such glasses include those manufactured by Sencofein or “Miralite Solar Premium” manufactured by Saint Gobain.

The pair of linear screw actuators 60, 62 by which the heliostat orientation is controlled are positioned substantially parallel, so that they both extend generally perpendicular to the mirror 14. This prevents the actuators 60, 62 from colliding during operation whilst giving a greater range of optimal angle to the heliostat 12. The actuators 60, 62 include individual off-the-shelf DC motors 65.

The actuators 60, 62 are arranged to provide control in two orthogonal directions so that the focussing point can be maintained for any angle of incident light. One axis is controlled east to west, i.e. side to side, and the other north to south, i.e. upward tilt. However, one axis is controlled relative to the other axis. Specifically, side-to-side rotation occurs about an intermediate mount in the form of a frame support bracket 66, which is itself rotated up or down: this arrangement minimises the amount of space taken up by each heliostat 12.

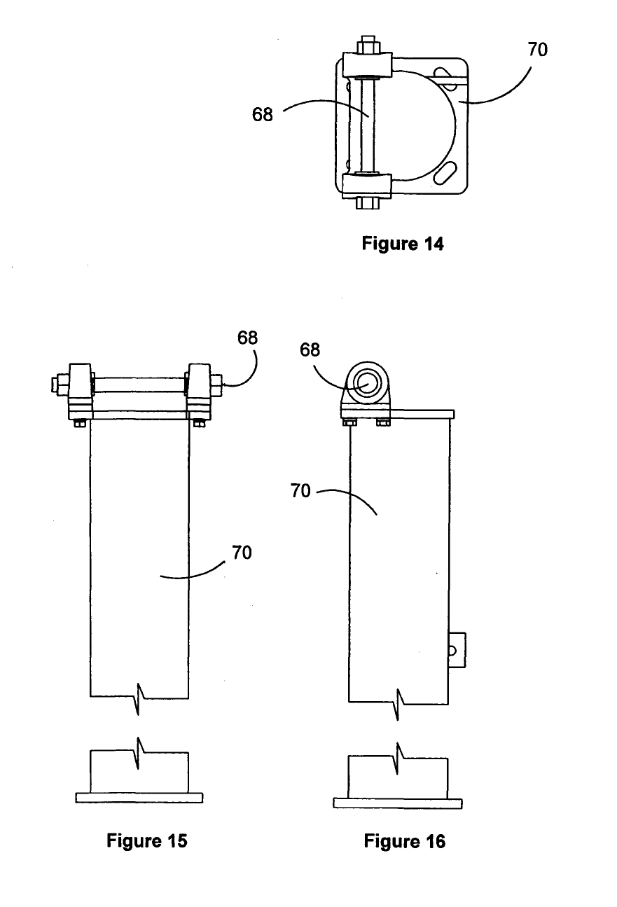

The frame 20 is connected to support bracket 66 at vertically spaced hinges 67 for rotation about an upright axis joining hinges 67. The first linear actuator 60 is mounted between the mirror frame 20 and an arm 64 that projects laterally rearwardly from support bracket 66, for controlling this side-to-side or east-west rotational movement. Bracket 66 is pivotally attached in turn, by bracket pin 68 (FIGS. 14-16), to the top of post 70. Pin 68 defines an inclination axis about which the tilt angle of bracket 66, and thereby of frame 20, is adjustable. The aforementioned upright axis is generally orthogonal to the inclination axis. Arm 64 is rigidly connected to the bracket 66 as close to the inclination axis as possible. Second actuator 62 extends between post 70 and an attachment point 69 at the lower end of bracket 66 for effecting adjustment of the tilt or inclination of the mirror.

The angle of the arm 64 to the bracket 66 is selected to provide optimum actuator geometry, with different angles for each heliostat according to positions in the field. The bracket 66 may further include a number of different attachment points 69 for the actuator 62 also selectable to provide the optimum angle according to the individual heliostat's position in the field.

Magnetic sensors 80 (FIG. 4) are used to measure the respective orientation or positional angles of each heliostat, defined by inclination and lateral orientation or declination. In contrast to conventional practice, these sensors are not high precision (˜12-16 bit) encoders or inclinometers but instead are inexpensive low precision (˜8 bit) encoders, e.g. hall effect encoders. Furthermore these encoders are deployed to determine motor shaft position rather than directly measuring the angular location of the mirror assembly.

System 10 is activated into operation by controller 40 using the actuators 60, 62 to bring the heliostats to substantially their optimum orientation at which all optimally receive a respective beam of sunlight and direct it to the primary target 13 of the solar energy receiver 12. When this concentrated composite beam is not being utilised to provide heat energy for the power plant coupled to the receiver, the system must be deactivated out of operation by adjusting the heliostats away from their optimal position to random uncorrelated orientations that do not result in any collectively focussed sunlight.

As mentioned earlier, controller 40 is programmed to carry out a number of calibration and control tasks in order to optimise the convertible energy received at primary target aperture 13. The first of the just-mentioned tasks is the calibration of each heliostat, and the second is to effect an angular adjustment of the heliostat in response to the calibration. By means of control signals from controller 40 to heliostat actuators 60, 62, one heliostat at a time has its angular position shifted by a small angle (typically about 5° and preferably broadly in the range 1-10° or more) so that the beam of sunlight reflected from the heliostat is directed to secondary target 30 rather than primary target 13. This position is held for a predetermined period (typically about 10 seconds and preferably broadly in the range 1 second to 1 minute) while camera 35 records a representation of the cross-sectional energy distribution in that beam, that is a flux image. To minimise the time each heliostat is off-line, the secondary target is positioned such that angular shift of preferably between 1 and 6° is required and more preferably between 2 and 5°, while a measurement time is preferably 30 seconds, more preferably 20 seconds or less and even more preferably 10 seconds or less. The combination of a secondary target in close proximity to the receiver and short measurement times to assess variations from a reference norm minimises the amount of time each heliostat is taken off line during each calibration.

Controller 40 is programmed with suitable logic and algorithms to analyse the flux image to estimate its centre. When this centre is not coincident with the geometric centre of the secondary target, or with a desired position of this beam matching its desired position at the primary target, the controller applies an angular adjustment or offset to the heliostat angular position when it is returned to its home position focused on primary target 13.

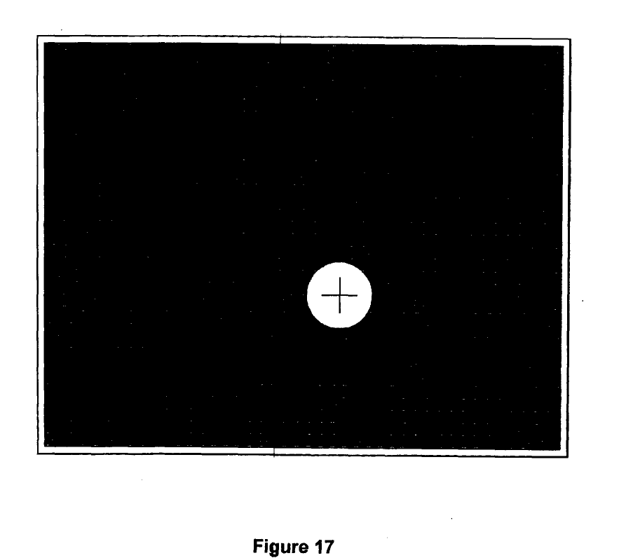

FIG. 17 is a diagram of the secondary target bearing a representative flux image 104 of a heliostat-reflected beam as it would be observed at secondary target 30 by camera 35. It can visually be seen that the energy flux centre (marked by the crosshairs) of the flux image is geometrically off-centre. The controller utilises any suitable known analytic tool to derive a geometric location of this centre, or centroid, of the flux image, and from this determines a correcting offset for the angular position of the respective heliostat.

Repetition of this process across all heliostats in turn during operation of the apparatus constitutes an “instantaneous” calibration of each heliostat and thus assists in real time optimisation of the focus of the reflected beams of sunlight onto the primary target aperture. Moreover, the arrangement is effective to improve the accuracy of receipt of the beam of sunlight and direction of the beam to the primary target, and so to compensate, by closed loop control during operation of the apparatus, for tolerances in heliostat and actuator geometries, including inaccuracies arising from the aforementioned use and deployment of the low precision orientation determination encoders, and from low precision installation techniques. It is preferred that calibration is continuously performed during solar plant operation by a controller managed program of sequentially taking each heliostat off primary target, directing its reflected beam to the secondary target 30, calibrating the heliostat, and adjusting its position to optimise the heliostat's contribution to the receiver aperture. The adjustment also makes allowance for the actual determined beam location relative to that reported by the low precision sensors 80.

Depending upon the size of the field and the number of receivers and associated secondary targets the proportion of heliostats effectively off-line due to the continuous calibration process may typically be with the range of 0.1% to 2%, and preferably in the range 0.2% to 1% of the total number of heliostats within the field.

The flux image acquired by way of the camera 35 is also employed to calibrate a model of the heliostat geometry. The aforedescribed calibration measurements for each heliostat are taken at multiple time points over a day whereby to acquire a set of offsets. As just described, these offsets are used each time to offset the actuator, and thereby heliostat, positions to cause the respective beams to be more accurately located in the primary target aperture. Closed loop control of heliostat position is thereby achieved. Any errors in the modelled geometry will cause small errors as the beam is moved back from the secondary target to the receiver primary target aperture. The target offsets can be employed to calibrate the geometry errors (over a longer time scale) and once the geometry errors have been calibrated out, the average offset position will be close to zero. The combination of open loop (from calibrations) and closed loop (from offsets) positioning results in highly accurate tracking, allowing compensation for the employment of inexpensive heliostat actuation fabrication methods, and for the consequent substantial tolerances in heliostat and actuator geometries.

To develop a calibration model, model equations are formed that describe the effect of misalignments as a function of heliostat and therefore sun position. These misalignments include rotation of the primary axis away from true east-west, tilt of the primary axis from horizontal, and deviation from orthogonality between the pivot axes. The linear actuator geometry is formed by a triangle with two fixed sides and one side of variable length, so that three parameters (side A, side B and side C with actuator fully retracted) are sufficient to describe each actuator geometry. With the XYZ position of each mirror there are twelve calibration terms in all. Persons skilled in the art will appreciate that it is possible to perform coordinate rotations and combinations to reduce the dimensions of the model: it is found that seven of these twelve terms can be measured directly leaving five terms to be determined experimentally. In fact, in accordance with the preferred practice of this invention, three measurements over 4 hourly intervals repeated at 3-monthly intervals are sufficient to determine the unknown calibration constants. The preferred method for this purpose is to use a weighted and constrained gradient descent method, although those skilled in the art will appreciate that any of the standard non-linear or linearised regression methods may be employed.

During commissioning there is insufficient data over a time scale of months to accurately determine all constants, so the less well determined parameters are given low weights and tight constraints initially. The closed loop positioning method provides reasonable accuracy until enough months have elapsed to traverse sufficient calibration space to obtain an accurate calibration model.

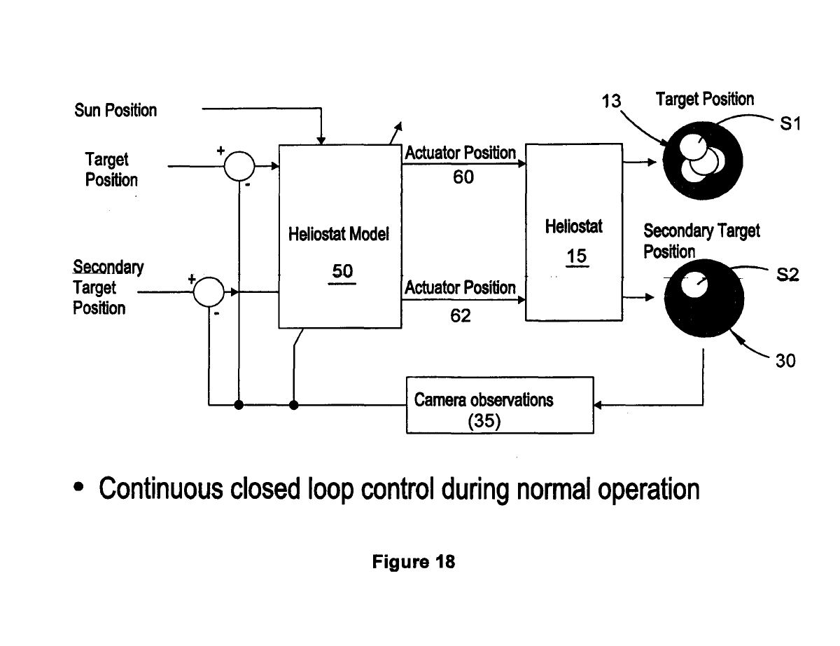

These concepts are elaborated upon diagrammatically in FIG. 18. Here, the discs S1 and S2 on the primary and second targets 13, 30 represent current image zones in which a selected percentage of the heliostat reflected energy is found. The image observed by the camera may be employed to determine an offset to adjust the relative positions on the targets and is also fed to the calibration model 50 for the respective heliostat. This diagram demonstrates the continuous closed loop control employed during normal operation of the central receiver solar energy collection system incorporating sequential adjustment of each heliostat to direct its reflected beam to the secondary target.

In an operational modification, secondary target 30 can be additionally employed as a stand-by receiver for one or more heliostats, a role able to be activated quickly when needed in order to manage or control flux and thermal performance of the primary target zone and/or receiver.

1. A solar energy collection apparatus comprising:
a solar energy receiver defining a primary target to receive directed sunlight;
a field of heliostats mounted for angular adjustment to optimally receive a beam of sunlight and direct it to the primary target of the solar energy receiver;
actuator means to effect said angular adjustment of each heliostat of the field;
a secondary target at or spaced from said primary target disposed so as not to be intercepted by said optimally received and directed beams of sunlight;
a controller operably coupled to said actuator means and configured to sequentially cause, during operation of the solar energy collection apparatus, a temporary angular adjustment of the respective said heliostats so as to divert the beam of sunlight received at each heliostat to said secondary target for a predetermined period of time, and
recordal means to record a representation of each diverted beam at the secondary target;
wherein the controller is also coupled to the recordal means and is further configured to respond to the representation of the diverted beam for the respective heliostats when a parameter or element thereof deviates from a reference norm, by activating the actuator means to angularly adjust the corresponding heliostat to improve the accuracy of its receipt of said beam of sunlight and direction of the beam to the primary target, thereby compensating by closed loop control of the field of heliostats during operation of the apparatus for tolerances in heliostat and actuator geometries.

2. The solar energy collection apparatus according to claim 1, wherein the controller is further configured so that on a continuous basis during operation of the solar energy collection apparatus, at least one heliostat is in a state of said temporary angular adjustment, whereby said closed loop control is a continuous closed loop control.

3.-4. (canceled)

5. The solar energy collection apparatus according to claim 1, wherein the actuator means includes a pair of linear actuators for respectively controlling the inclination and declination of a reflecting surface of the heliostat, and wherein said heliostats include a mirror, a support frame for the mirror, and an intermediate mount for the frame, and said pair of linear actuators are arranged for respectively rotationally adjusting the intermediate mount about a first axis and rotationally adjusting the frame relative to the intermediate mount about a second axis.

6.-9. (canceled)

10. The solar energy collection apparatus according to claim 1, wherein said secondary target comprises a highly reflective surface,
and said representation is a two-dimensional flux image representative of a cross-section of any sunlight beam that impinges on the secondary target.

11. (canceled)

12. The solar energy collection apparatus according to claim 1, wherein said recordal means is a camera at or near a ground surface on which the field of heliostats is mounted.

13. The solar energy collection apparatus according to claim 1, wherein said temporary angular adjustment is in the range 1 to 10°, and said predetermined period of time is in the range 1 second to 1 minute.

14. (canceled)

15. The solar energy collection apparatus according to claim 1, wherein said controller is further configured to cause a said representation to be acquired for each of multiple heliostats at different times over a day and over an extended period of multiple days and for corresponding angular positions of the heliostat, whereby to obtain a calibration model for the heliostats with respect to multiple time points as well as the geometry of the heliostats, and whereby to achieve a combination of open loop and closed loop control of the positions of the heliostats.

16. The solar energy collection apparatus according to claim 1, wherein the controller is further configured to manage or control flux end thermal performance of the primary target and/or receiver by diverting one or more heliostat beams to the secondary target, which thereby serves as a stand-by receiver.

17. The solar energy collection apparatus according to claim 1, wherein said heliostats include low precision sensors for determining the angular position of the heliostat mirror.

18. A method of calibrating multiple heliostats of a solar energy collection apparatus that includes a solar energy receiver defining a primary target to receive directed sunlight, and a field of heliostats each mounted for angular adjustment to optimally receive a beam of sunlight and direct it to the primary target of the solar energy receiver, the method comprising:
during operation of the solar energy apparatus, sequentially causing a temporary angular adjustment of the respective said heliostats so as to divert the beam of sunlight received at each heliostat to a secondary target for a predetermined period of time, which secondary target is at or spaced from the primary target and disposed so as not to be intercepted by said optimally received and directed beams of sunlight,
thereafter returning the heliostat to a position wherein the received beam of sunlight is directed to the primary target,
recording a representation of each directed beam at the secondary target; and
responding to the representation of the diverted beam for the respective heliostats when a parameter or element thereof deviates from a reference norm, by angularly adjusting the corresponding heliostat to improve the accuracy of its receipt of said beam of sunlight and direction of the beam to the primary target, thereby compensating by closed loop control of the field of heliostats during operation of the apparatus for tolerances in heliostat and actuator geometries.

19.-26. (canceled)

27. A solar energy collection apparatus comprising:
a solar energy receiver defining a primary target to receive directed sunlight;
a field of heliostats each mounted for angular adjustment to optimally receive a beam of sunlight and direct it to the primary target of the solar energy receiver;
actuator means to effect said angular adjustment of each heliostat of the field;
a secondary target;
means to record a representation of each directed beam at the secondary target, which representation is a characterisation of the corresponding heliostat at that time; and
a controller operably coupled to the representation recording means and configured to cause a said representation to be acquired for each of multiple heliostats at different times over a day and over an extended period of multiple days and for corresponding angular positions of the heliostat, whereby to obtain a calibration model for the heliostats with respect to multiple time points as well as the geometry of the heliostats.

28. The solar energy collection apparatus according to claim 27, wherein said representations are recorded on a continuous basis during operation of the solar energy collection apparatus.

29.-30. (canceled)

31. The solar energy collection apparatus according to claim 27, wherein the actuator means includes a pair of linear actuators for respectively controlling the inclination and declination of a reflecting surface of the heliostat,
and wherein said heliostats include a mirror, a support frame for the mirror, and an intermediate mount for the frame, and said pair of linear actuators are arranged for respectively rotationally adjusting the intermediate mount about a first axis and rotationally adjusting the frame relative to the intermediate mount about a second axis.

32.-35. (canceled)

36. The solar energy collection apparatus according to claim 27, wherein said secondary target comprises a highly reflective surface,
and said representation is a two-dimensional flux image representative of a cross-section of any sunlight beam that impinges on the secondary target.

37. (canceled)

38. The solar energy collection apparatus according to claim 27, wherein said recordal means is a camera at or near a ground surface on which the field of heliostats is mounted.

39.-43. (canceled)

44. The solar energy collection apparatus according to claim 15, wherein said controller is configured whereby said extended period of multiple days comprises a time scale of several months.

45. The solar energy collection apparatus according to claim 15, wherein said controller is configured whereby a said representation is acquired for each of multiple heliostats at different times over a day at intervals of a plurality of months.

46. The solar energy collection apparatus according to claim 17, wherein said low precision sensors are arranged to determine the angular position of the respective heliostat mirror by determining actuator motor shaft position.

47. The solar energy collection apparatus according to claim 17, wherein said low precision sensors have a precision of the order of 8-bit.

48. The solar energy collection apparatus according to claim 27, wherein said controller is configured whereby said extended period of multiple days comprises a time scale of several months.

49. The solar energy collection apparatus according to claim 27, wherein said controller is configured whereby a said representation is acquired for each of multiple heliostats at different times over a day at intervals of a plurality of months.

50. The solar energy collection apparatus according to claim 1, wherein said angular adjustment of the corresponding heliostat comprises an offset selected from a set of offsets determined by calibration measurements taken at multiple time points over a day.
